(19) United States
(12) Patent Application Publication
(10) Pub. No.: US 2012/0144044 A1
(43) Pub. Date: Jun. 7, 2012

(54) SYSTEM FOR AND METHOD OF DYNAMICALLY DEPLOYING SERVERS

(75) Inventor: Navneet VERMA, Ashburn, VA (US)

(73) Assignee: VERIZON PATENT AND LICENSING INC., Basking Ridge, NJ (US)

(21) Appl. No.: 12/960,619

(22) Filed: Dec. 6, 2010

(51) Int. Cl. G06F 15/16

(52) U.S. Cl. 709/227

(57) ABSTRACT

A system for and method of dynamically deploying servers is presented. The system and method may include establishing a communication link with a deployment client workstation, capturing data associated with the deployment client workstation, creating a deployment file based at least in part on the data associated with the deployment client workstation, and providing the deployment file to a deployment server engine via a network.

### BACKGROUND INFORMATION

In general, users may access resources available over networks, such as the Internet. Typically, many servers exist to serve such resources to users, and the particular server that provides a resource to an individual user is unknown to the user. Many servers have dedicated functionality such as web servers, print servers, and database servers. Server also provides essential services across a network, either to private users inside an organization or to public users via the Internet. Oftentimes, server deployments may be labor intensive and human error prone. Server deployment may require a process that meets the quality standards of various clients' needs. Thus, an efficient, cost effective deployment process may be needed

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram illustrating a dynamic server deployment system according to particular embodiments;

FIG. 2 is a block diagram of a hardware component of the deployment workstation of a particular embodiment;

FIG. 3 is a flowchart illustrating the functionality for dynamically deploying servers according to a particular embodiment; and

FIGS. 4-12 are screenshots of a graphical user interface for requesting administrator information for dynamically deploying servers of a particular embodiment.

### DETAILED DESCRIPTION OF PREFERRED EMBODIMENTS

An exemplary embodiment provides a system and a method for dynamically deploying servers. A dynamic deployment workstation may capture client data associated with a deployment client workstation. The dynamic deployment workstation may be a workstation used by a technician, an administrator, or an engineer to dynamically deploy servers. The deployment client workstation may be workstations associated with clients served by the dynamically deployed servers. For example, the dynamic deployment workstation may automatically capture client data associated with a deployment client workstation. The dynamic deployment workstation may create a server deployment file based at least in part on the client data. The server deployment file may be provided to a deployment server engine via an communication network for processing. Also, the deployment server engine may store the server deployment file in a deployment server database.

The deployment workstation may provide the server deployment file to a deployment client agent. The deployment client agent may process the server deployment file and provide the serve deployment file to the deployment server engine. The deployment server engine may match the server deployment file provided by the deployment workstation with the server deployment file provided by the deployment client agent. The deployment server engine may deploy and configure servers based at least in part on the server deployment file. The deployment server engine may capture deployment and configuration data associated with the one or more servers deployed based at least in part on the server deployment file. The deployment server engine may provide the deployment and configuration data associated with the deployed servers to the deployment client agent and stored.

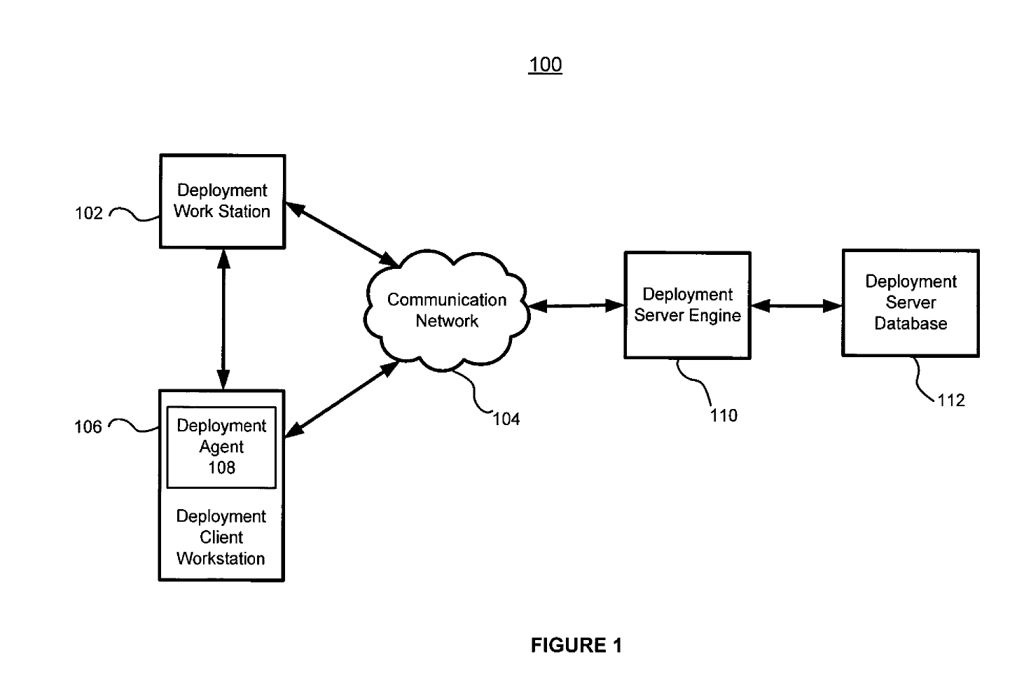

FIG. 1 is a schematic diagram illustrating a dynamic server deployment system according to particular embodiments. As illustrated in FIG. 1, the dynamic server deployment system 100 may include a deployment workstation 102 coupled to a deployment client workstation 106. In an exemplary embodiment, the deployment workstation 102 may be coupled to the deployment client workstation 106 via a wired link when the deployment workstation 102 is located at a location associated with the deployment client workstation 106. In another exemplary embodiment, the deployment workstation 102 may be coupled to the deployment client workstation 106 via the communication network 104 when the deployment workstation 102 is located at a location associated with the deployment server engine 110.

The deployment client workstation 106 may include a deployment agent 108 to facilitate the deployment of one or more servers. The deployment workstation 102 may be coupled to a deployment server engine 110 via a communication network 104. The deployment server engine 110 may be coupled to a deployment server database 112 to store data associated with the deployment of servers. For example, the deployment workstation 102 may capture or gather client data associated with the deployment client workstation 106. The deployment workstation 102 may request information associated with an administrator. The deployment workstation 102 may create a server deployment file based at least in part on the client data associated with the deployment client workstation 106 and the information associated with the administrator. The deployment workstation 102 may provide the server deployment file to the deployment server engine 110 via the communication network 104. The deployment server engine 110 may process the server deployment file and store the server deployment file in the deployment server database 112. The deployment server engine 110 may prepare to deploy servers based at least in part on the server deployment file.

The deployment workstation 102 may provide the server deployment file to the deployment agent 108 of the deployment client workstation 106. The deployment agent 108 may process the server deployment file and provide the server deployment file to the deployment server engine 110. The deployment server engine 110 may match the server deployment file provided by the deployment workstation 102 and the server deployment file provided by the deployment agent 108. The deployment server engine 110 may deploy and configure servers based at least in part on the server deployment file. The deployment server engine 110 may store deployment and configuration data associated with the deployed servers in the deployment server database 112. The deployment server engine 110 may provide the deployment and configuration data to the deployment client workstation 106 and stored. Also, the deployment agent 108 may configure the deployment client workstation 106 based at least in part on the deployment and configuration data.

The deployment workstation 102 may be a computer, a personal computer, a laptop, a cellular communication device, a workstation, a mobile device, a phone, a handheld PC, a personal digital assistant (PDA), a thin system, a fat system, a network appliance, an Internet browser, or other any other device that may be in communication with the deployment server engine 110 via the communication network 104. The deployment workstation 102 may be coupled to the deployment client workstation 106 via a wired link. In another exemplary embodiment, the deployment workstation 102 may be coupled to the deployment client workstation 106 via a wireless link.

The communication network 104 may be coupled to the deployment workstation 102, deployment client workstation 106, and the deployment server engine 110. The communication network 104 may be a wireless network, a wired network or any combination of wireless network and wired network. For example, the communication network 104 may include one or more of a fiber optics network, a passive optical network, a cable network, an Internet network, a satellite network (e.g., operating in Band C, Band Ku or Band Ka), a wireless LAN, a Global System for Mobile Communication (GSM), a Personal Communication Service (PCS), a Personal Area Network (PAN), D-AMPS, Wi-Fi, Fixed Wireless Data, IEEE 802.11a, 802.11b, 802.15.1, 802.11n and 802.11g or any other wired or wireless network for transmitting and receiving a data signal. In addition, the communication network 104 may include, without limitation, telephone line, fiber optics, IEEE Ethernet 802.3, wide area network (WAN), local area network (LAN), or global network such as the Internet. The communication network 104 may support an Internet network, a wireless communication network, a cellular network, or the like, or any combination thereof.

The communication network 104 may further include one, or any number of the exemplary types of networks mentioned above operating as a stand-alone network or in cooperation with each other. Although the communication network 104 is depicted as one network, it should be appreciated that according to one or more embodiments, the communication network 104 may comprise a plurality of interconnected networks, such as, for example, a service provider network, the Internet, a broadcaster's network, a cable television network, corporate networks, and home networks.

The deployment client workstation 106 may be a computer, a personal computer, a laptop, a cellular communication device, a workstation, a mobile device, a phone, a handheld PC, a personal digital assistant (PDA), a thin system, a fat system, a network appliance, an Internet browser, or other any other device that may be in communication with the deployment server engine 110 via the communication network 104.

The deployment client workstation 106 may also include one or more servers. For example, the deployment client workstation 106 may include a UNIX based server, Windows 2000 Server, Microsoft IIS server, Apache HTTP server, API server, Java sever, Java Servlet API server, ASP server, PHP server, HTTP server, Mac OS X server, Oracle server, IP server, or other independent server to support operations of a client. Also, the deployment client workstation 106 may include one or more Internet Protocol (IP) network server or public switch telephone network (PSTN) server. The deployment client workstation 106 may store a server deployment file received from the deployment workstation 102.

The deployment server database 112 may include one or more storage devices including, without limitation, paper card storage, punched card, tape storage, paper tape, magnetic tape, disk storage, gramophone record, floppy disk, hard disk, ZIP disk, holographic, molecular memory. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD and Phase-change Dual storage device. The one or more storage devices may further include, without limitation, magnetic bubble memory, magnetic drum, core memory, core rope memory, thin film memory, twistor memory, flash memory, memory card, semiconductor memory, solid state semiconductor memory or any other like mobile storage devices.

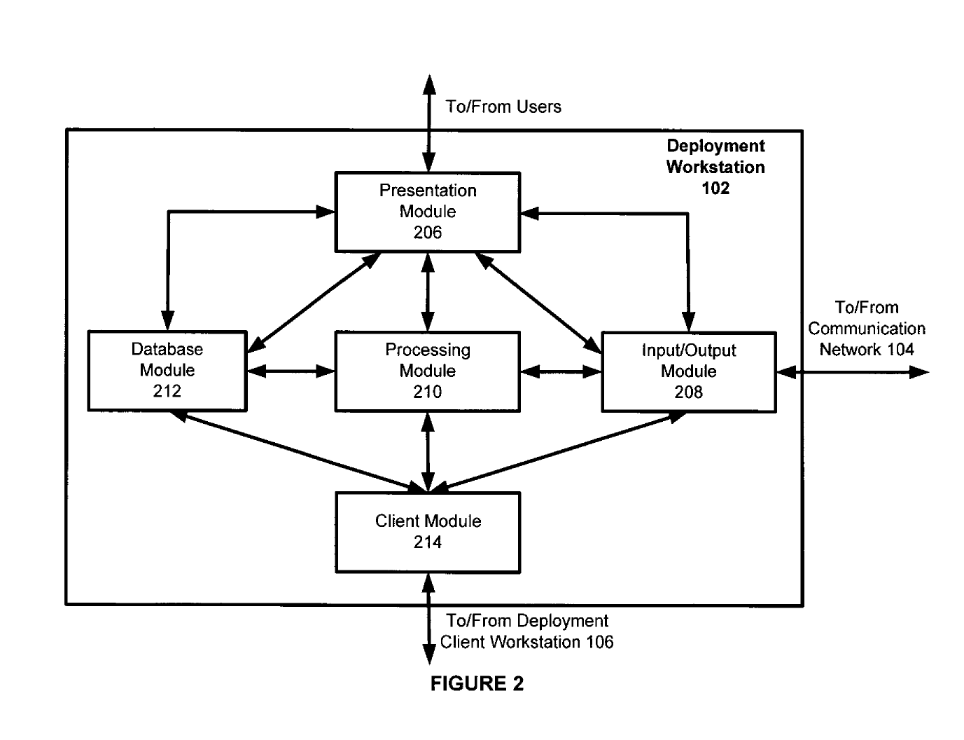

FIG. 2 is a block diagram of a hardware component of the deployment workstation of a particular embodiment. The deployment workstation 102 may include a presentation module 206, an input/output (I/O) module 208, a processing module 210, a database module 212, or a client module 214. It is noted that the modules 206, 208, 210, 212, and 214 are exemplary and the functions performed by one or more of the modules may be combined with that performed by other modules. The functions described herein as being performed by the modules 206, 208, 210, 212, and 214 also may be separated and may be located or performed by other modules. Moreover, the modules 206, 208, 210, 212, and 214 may be implemented at other devices of the dynamic server configuration system 100 (e.g., the communication network 104, the deployment client workstation 106, or the deployment agent 108).

The presentation module 206 may provide an interface between administrators and the deployment client workstation 106. The presentation module 206 may include a user interface, e.g., a graphical user interface, to receive one or more queries/requests from the administrator. The presentation module 206 may provide a separate or a unified graphical user interface. The presentation module 206 may include an Application Programming Interface (API) to interact with the administrator of the deployment workstation 102. In an exemplary embodiment, the presentation module 206 may present one or more input requests or displays to the administrator of the deployment workstation 102. For example, the presentation module 206 may provide input requests to the administrators for user information, server information, server location, database information, network information, network connection, operating environment information, directory information, or other requests for information to dynamically deploy servers.

The presentation module 206 may receive administrator information from an administrator using the deployment workstation 102. In response to receiving the administrator information from an administrator of the deployment workstation 102, the presentation module 206 may provide the administrator information to the input/output (I/O) module 208, the processing module 210, the database module 212, and the client module 214. For example, the presentation module 206 may provide the administrator information to the processing module 210 to create a server deployment file. The deployment file may include the administrator information requested by the presentation module 206. The presentation module 206 may provide the administrator information to the input/output (I/O) module 208 to be transferred to the deployment server engine 110. The presentation module 206 may also provide the administrator information to the database module 212 and stored. The presentation module 206 may provide the administrator information to the client module 214 in order to capture the appropriate client data from the deployment client workstation 106.

The presentation module 206 may receive one or more queries/requests from the administrator to dynamically deploy servers. For example, an administrator may input a request to the presentation module 206 to dynamically deploy servers. In an exemplary embodiment, a user may input one or more queries/requests to dynamically deploy servers based at least in part on information associated with deployment server engine 110. The information associated with deployment server engine 110 may include a time, date, servers location, operating system, server address, gateway information, and other information associated with the deployment server engine 110.

The input/output (I/O) module 208 may include routers, repeater, antennas, USB ports, or other transceiver device for transmitting data to and receiving data from the deployment server engine 110. For example, the input/output (I/O) module 208 may receive client data from the client module 214. In another exemplary embodiment, the input/output (I/O) module 208 may receive client data directly from the deployment client workstation 106. For example, the input/output (I/O) module 208 may establish a communication link with the deployment client workstation 106 and capture or receive client data from the deployment client workstation 106. The client data may include data associated with the deployment client workstation 106. For example, the client data associated with the deployment client workstation 106 may include hardware data and software data associated with the deployment client workstation 106. The hardware data associated with the deployment client workstation 106 may include wireless card, processor, server, RAM, ROM, connections, traffic cards, and other devices of the deployment client workstation 106. The software data associated with the deployment client workstation 106 may include operating system, network identification, address information (e.g., uniform resource identifiers (URI), uniform resource locators (URL)), serial numbers/media access control (MAC) address, protocols, encryptions, and other software of the deployment client workstation 106.

The input/output (I/O) module 208 may preprocess the client data captured from the deployment client workstation 106 (e.g., filter, sort, format, and aggregate). In an exemplary embodiment, the preprocessing of the client data captured by the input/output (I/O) module 208 or the client module 214 may include filtering the client data and eliminating erroneous or defective client data, sorting the client data, formatting the client data into desired format (e.g., identify various portions of the client data), and aggregating the client data from the deployment client workstation 106.

The client data may be transferred from the input/output (I/O) module 208 to the processing module 210 for processing. The processing module 210 may process the client data to perform various operations. The processing module 210 may include a processor or a plurality of sub-analytical modules having a processor to perform various operations. For example, the processing module 210 may identify client data associated with the deployment client workstation 106. The processing module 210 may determine client data captured from the deployment client workstation 106. In an exemplary embodiment, the processing module 210 may dynamically determine the hardware information associated with deployment client workstation 106 and the software information associated with the deployment client workstation 106. The processing module 210 may format the client data captured from the deployment client workstation 106. In an exemplary embodiment, the processing module 210 may configure the client data into a format that may be compatible with the deployment client workstation 106. In another exemplary embodiment, the processing module 210 may configure the client data into a format that may be compatible with the deployment server engine 110. The processing module 210 may convert the client data from a first format to a second format.

The processing module 210 may dynamically create a server deployment file based at least in part on the client data captured from the deployment client workstation 106. In an exemplary embodiment, the server deployment file may include client data captured from the deployment client workstation 106. In another exemplary embodiment, the server deployment file may include hardware information of the deployment client workstation 106 or the software information of the deployment client workstation 106. The processing module 210 may dynamically create the server deployment file in various formats. The processing module 210 may dynamically create the server deployment file in various text format, spreadsheet format, or other text files containing client data captured from the deployment client workstation 106. In an exemplary embodiment, the processing module 210 may dynamically create the server deployment file in a comma-separated values or character-separated values file.

The processing module 210 may dynamically create a server deployment file including administrator information. The processing module 210 may configure the administrator information into appropriate format and dynamically create a server deployment file. For example, the processing module 210 may dynamically create a server deployment file having only the administrator information. In another exemplary embodiment, the processing module 210 may dynamically create a server deployment file including administrator information and client data captured from the deployment client workstation 106. The processing module 210 may store the server deployment file in the database module 212.

The database module 212 may store and manage client data captured from the deployment client workstation 106, administrator information, and the server deployment file. For example, the client data may be captured from the deployment client workstation 106 by the input/output (I/O) module 208 or the client module 214 may be stored in the database module 212. The presentation module 206 may receive administrator information from the user of the deployment workstation 102 and stored in the database module 212. The processing module 210 may create a server deployment file and stored in the database module 212. The database module 212 may provide an interface, e.g., a uniform interface, for other modules within the deployment workstation 102 and may write, read, and search data stored in one or more repositories or databases. The database module 212 may also perform other functions, such as, but not limited to, concurrent access, backup and archive functions. Due to limited amount of storing space the database module 212 may compress, store, transfer or discard data stored within, after a period of time, e.g., a year.

Various modules of the deployment workstation 102 may access the database module 212 to obtain client data captured from the deployment client workstation 106, administrator information, and the server deployment file. For example, the processing module 210 may access the database module 212 to obtain the client data captured from the deployment client workstation 106 to create a server deployment file. The processing module 210 may also access the database module 212 to obtain the administrator information to create a server deployment file.

The database module 212 may be network accessible storage and may be local, remote, or a combination thereof to modules 206, 208, 210, and/or 214. The database module 212 may utilize a redundant array of inexpensive disks (RAID), tape, disk, a storage area network (SAN), an internet small computer systems interface (iSCSI) SAN, a Fibre Channel SAN, a common Internet File System (CIFS), network attached storage (NAS), a network file system (NFS), or other computer accessible storage. In one or more embodiments, database module 212 may be a database, such as an Oracle® database, a Microsoft® SQL Server database, a DB2 database, a MySQL® database, a Sybase® database, an object oriented database, a hierarchical database, or other database. The database module 212 may utilize flat file structures for storage of data.

The client module 214 may establish a communication link with the deployment client workstation 106 and may capture or receive client data from the deployment client workstation 106. For example, the client module 214 may include one or more connection ports to couple the deployment workstation 102 to the deployment client workstation 106. The client module 214 may access the deployment client workstation 106 via the communication link and capture client data associated with the deployment client workstation 106. The client module 214 may store client data associated with the deployment client workstation 106. The client module 214 may format the client data of deployment client workstation 106 into desired format. In an exemplary embodiment, the desired format for storing the client data associated with the deployment client workstation 106 may include tables, hash tables, search trees, matrix, spread sheets, models, array structure, linear representation, or other representations of the client data of the deployment client workstation 106.

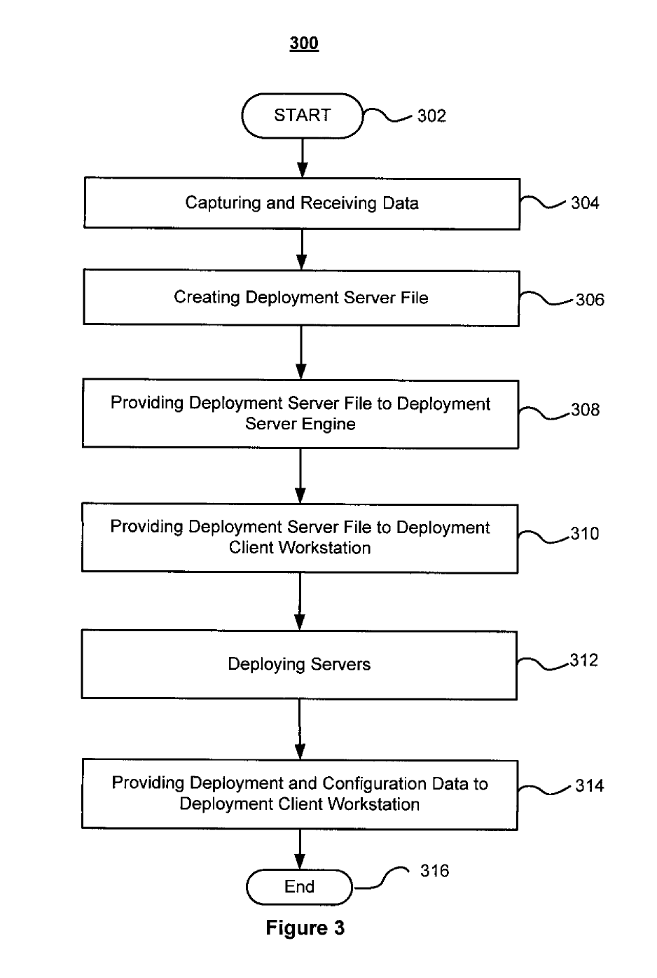

FIG. 3 is a flowchart illustrating the functionality for dynamically deploying servers according to a particular embodiment. This exemplary method 300 may be provided by way of example, as there are a variety of ways to carry out the method. The method 300 shown in FIG. 3 can be executed or otherwise performed by one or a combination of various systems. The method 300 is described below may be carried out by the system and network shown in FIGS. 1 and 2, by way of example, and various elements of the system and network are referenced in explaining the example method of FIG. 3. Each block shown in FIG. 3 represents one or more processes, methods or subroutines carried out in exemplary method 300. Referring to FIG. 3, exemplary method 300 may begin at block 302.

At block 302, the method 300 for dynamically deploying servers may begin.

At block 304, the deployment workstation 102 may capture and receive data to dynamically deploy servers. The deployment workstation 102 may establish a communication link with the deployment client workstation 106 via the client module 214. In an exemplary embodiment, the deployment workstation 102 may be located at a location associated with the deployment client workstation 106. The deployment workstation 102 may be directly coupled to the deployment client workstation 106 (e.g., an USB port). In another exemplary embodiment, the deployment workstation 102 may be located at a location associated with the deployment server engine 110. The deployment workstation 102 may establish a communication link to the deployment client workstation 106 via the communication network 104. The client module 214 may automatically capture client data associated with the deployment client workstation 106. For example, the client module 214 may capture software information and hardware information associated with the deployment client workstation 106. The client module 214 may provide the captured client data associated with the deployment client workstation 106 to the database module 212 and stored.

The deployment workstation 102 may provide one or more requests for administrator information. For example, the presentation module 206 may provide one or more requests for administrator information via a graphical user interface (GUI). The presentation module 206 may provide requests for administrator information associated with dynamically deploying servers. For example, the presentation module 206 may provide request for user information, server information, database information, network information, network connection, production environment information, directory information, or other requests for information to dynamically deploy servers. The presentation module 206 may provide the received administrator information to the database module 212 and stored. After capturing and receiving data, the method 300 may proceed to block 304.

At block 306, the deployment workstation 102 may create a server deployment file. For example, the processing module 210 may access the database module 212 or the client module 214 to obtain the client data associated with the deployment client workstation 106. The processing module 210 may access the database module 212 or the presentation module 206 to obtain the administrator information. The processing module 210 may create a server deployment file based at least in part on the client data associated with the deployment client workstation 106 and the administrator information. In an exemplary embodiment, the processing module 210 may create a server deployment file containing the client data associated with deployment client workstation 106 and the administrator information. The processing module 210 may create the server deployment file using a comma-separated values or character-separated values format. The processing module 210 may provide the server deployment file to the database module 212 and stored. After creating the server deployment file, the method 300 may proceed to block 308.

At block 308, the deployment workstation 102 may provide the server deployment file to the deployment server engine 110. The processing module 210 may provide the server deployment file to the input/output (I/O) module 208 and transmitted to the deployment server engine 110 via the communication network 104. The deployment server engine 110 may process the server deployment file. For example, the deployment server engine 110 may prepare servers based at least in part on the server deployment file. The deployment server engine 110 may prepare servers according to the client data associated with the deployment client workstation 106 and the administrator information contained in the server deployment file. The deployment server engine 110 may provide the server deployment file to the deployment server database 112 and stored. After providing server deployment file to the deployment server engine 110, the method may proceed to block 310.

At block 310, the deployment workstation 102 may provide the server deployment file to the deployment client workstation 106. The processing module 210 may provide the server deployment file to the client module 214 and transmitted to the deployment client workstation 106. In an exemplary embodiment, the client module 214 may provide the server deployment file to the deployment client workstation 106 when the input/output (I/O) module 208 provide the server deployment file to the deployment server engine 110. The deployment agent 108 of the deployment client workstation 106 may process the server deployment file. For example, the deployment agent 108 may prepare the deployment client workstation 106 to dynamically deploy servers based at least in part on the server deployment file. The deployment agent 108 of the deployment client workstation 106 may provide the server deployment file to the deployment server engine 110 via the communication network 104. After providing server deployment file to the deployment client workstation 106, the method 300 may proceed to block 312.

At block 312, the deployment server engine 110 may dynamically deploy servers. For example, the deployment server engine 110 may match the server deployment file provided by the deployment workstation 102 and the server deployment file provided by the deployment client workstation 106. The deployment server engine 110 may determine that the server deployment file provided by the deployment workstation 102 matches the server deployment file provided by the deployment client workstation 106. The deployment server engine 110 may dynamically deploy servers based at least in part on the server deployment file provided by the deployment workstation 102 and the server deployment file provided by the deployment client workstation 106. The deployment server engine 110 may capture deployment and configuration data from the deployed servers. The deployment server engine 110 may store the deployment and configuration data from the deployed servers. After dynamically deploying servers, the method 300 may proceed to block 314.

At block 314, the deployment server engine 110 may provide the deployment and configuration data to the deployment client workstation 106. For example, the deployment server engine may capture the deployment and configuration data of the deployed servers and provide the deployment and configuration data to the deployment client workstation 106. The deployment client workstation 106 may store the deployment and configuration data of the deployed servers. Also, the deployment client workstation 106 may configure itself based at least in part on the deployment and configuration data provided by the deployment server engine 110. After providing the deployment and configuration data to the deployment client workstation 106, the method 300 may proceed to block 316.

At block, 316, the method 300 for dynamically deploying servers may end.

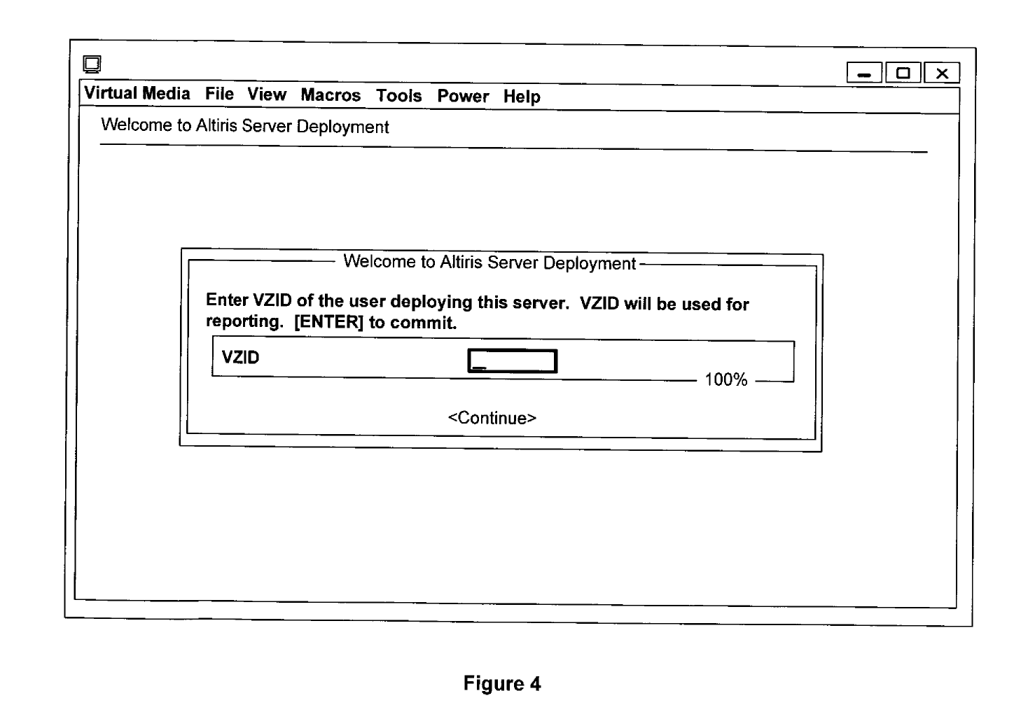

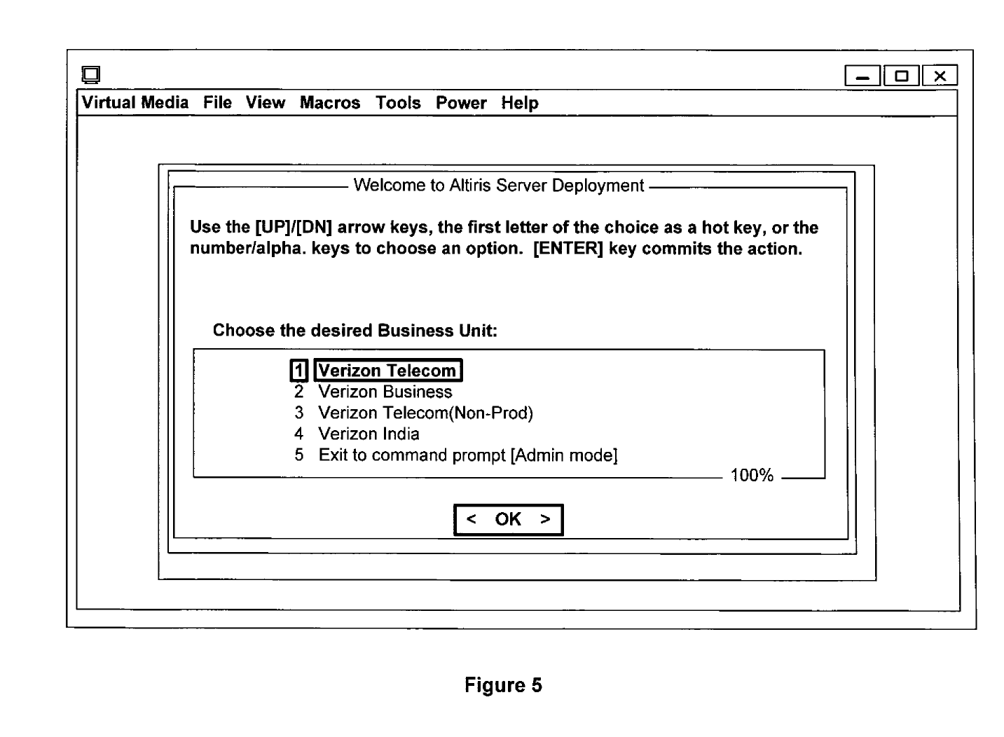

FIGS. 4-12 are screenshots of a graphical user interface for requesting administrator information for dynamically deploying servers of a particular embodiment. As discussed above, the presentation module 206 may present graphical user interface to request information from an administrator in order to create server deployment file. The graphical user interface may request various information from the administrator. FIG. 4, shows that the graphical user interface may request identification information of the administrator. For example, the graphical user interface may request an identification number or name of the administrator. FIG. 5, shows that the graphical user interface may request an organization information associated with the administrator. For example, the graphical interface may request an organization, a department, a subsidiary, a division, or a business unit associated with the administrator.

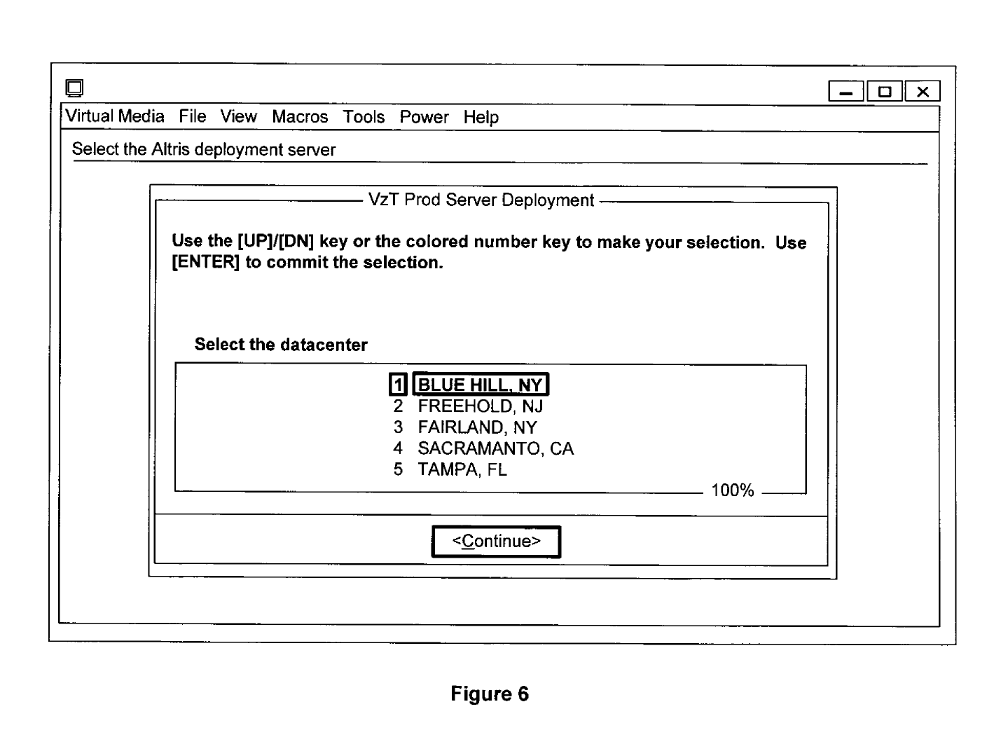

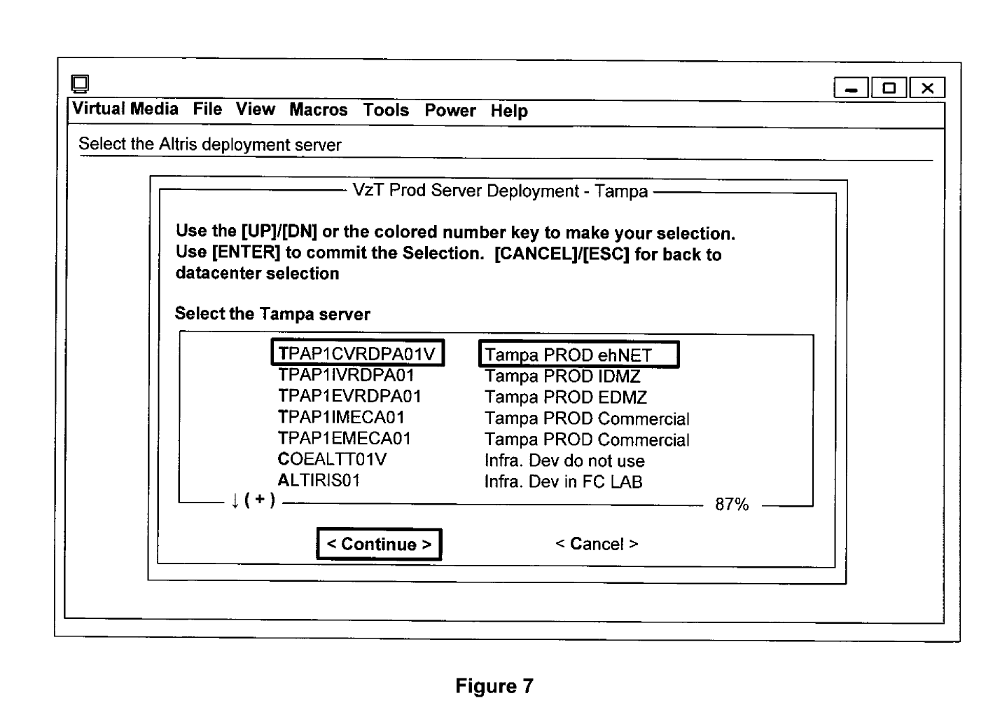

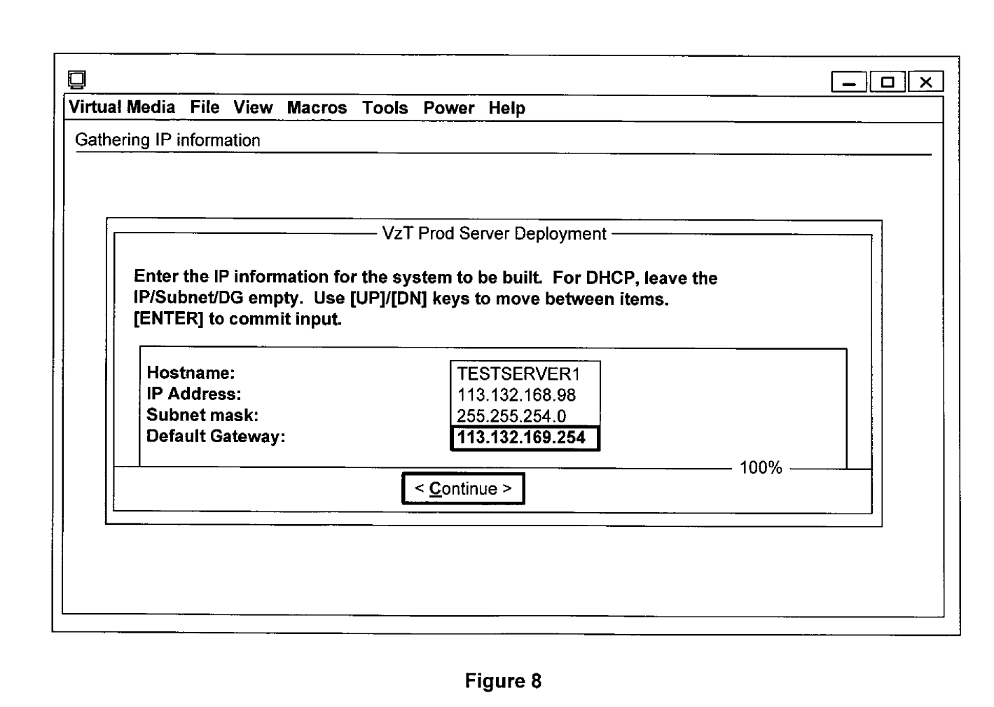

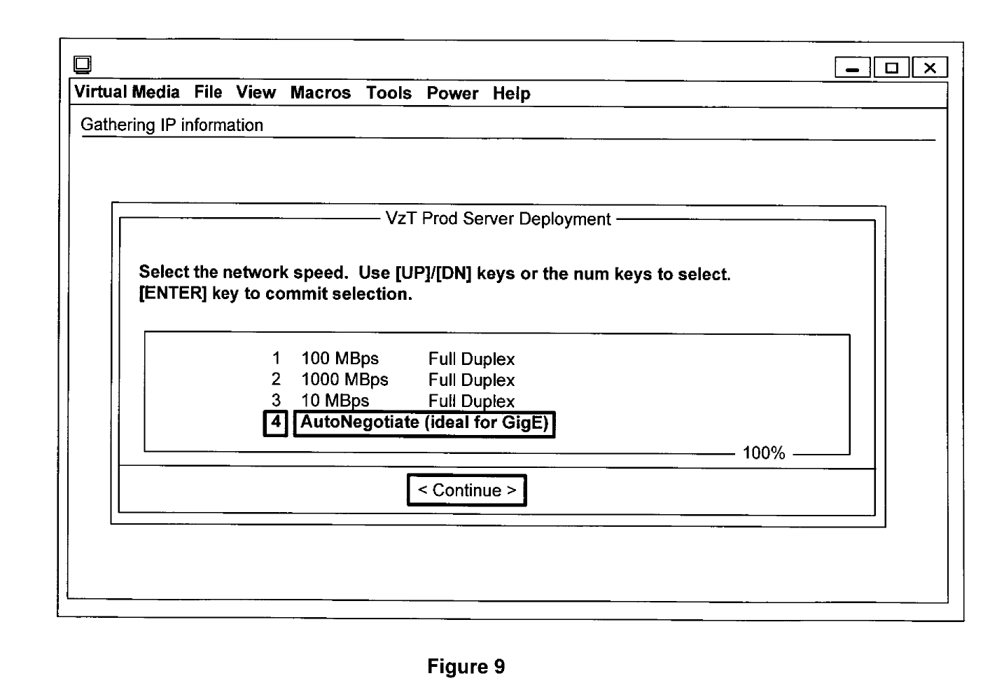

The presentation module 206 may present graphical user interface to request information associated with dynamically deploying the servers. FIG. 6, shows that the graphical user interface may request a location of the servers to be deployed. For example, the graphical interface may request an location information of datacenters where the servers are to be dynamically deployed. FIG. 7, shows that the graphical user interface may request one or more servers to be dynamically deployed. For example, the graphical user interface may request the administrator to identify one or more servers located at the selected datacenter to be dynamically deployed. FIG. 8, shows that the graphical user interface may request network information associated with dynamically deployed servers. For example, the graphical user interface may request network information (e.g., hostname, IP address, subnet mask, default gateway, or IP stack) associated with dynamically deployed servers. The network information associated with dynamically deployed servers may include network speed associated with dynamically deployed servers. FIG. 9, shows that the graphical user interface may request the administrator to select the network speed of the dynamically deployed servers.

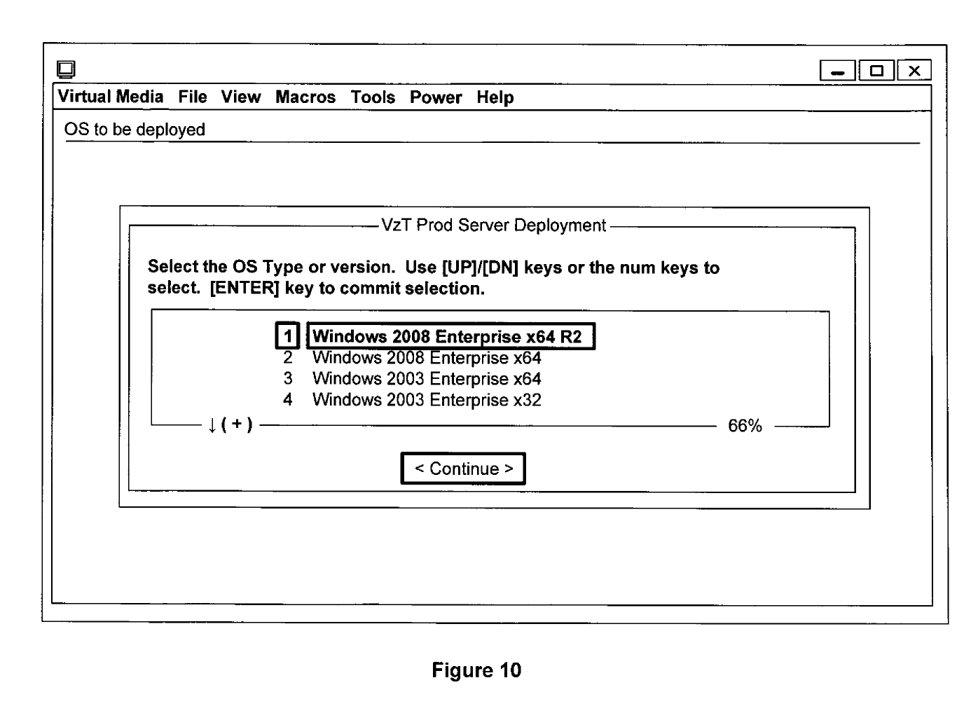

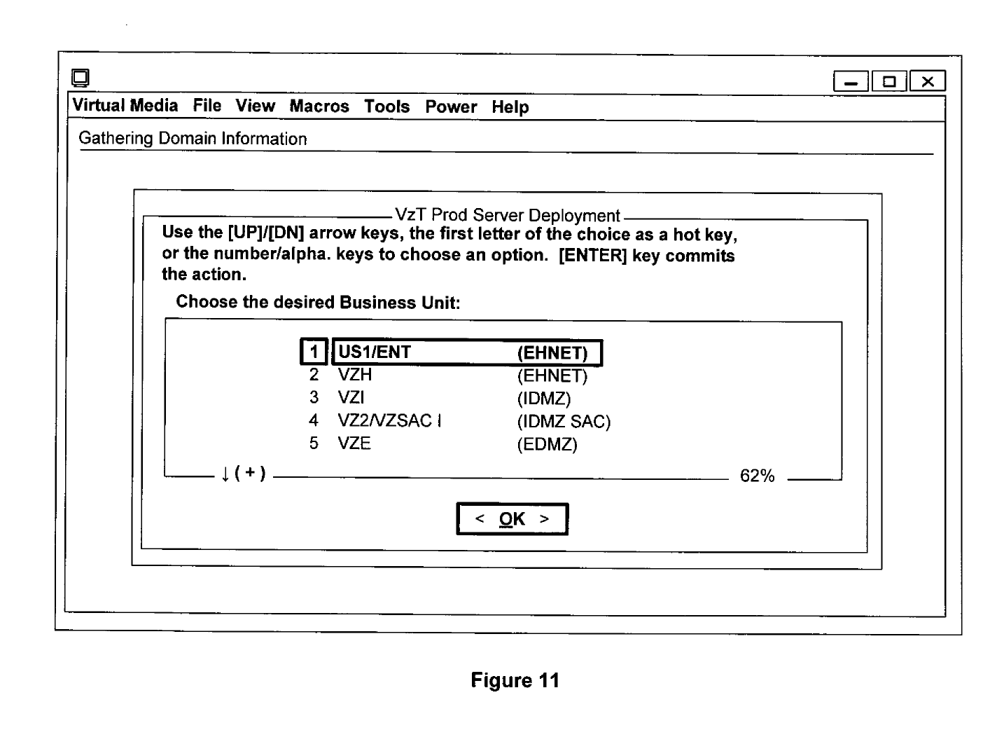

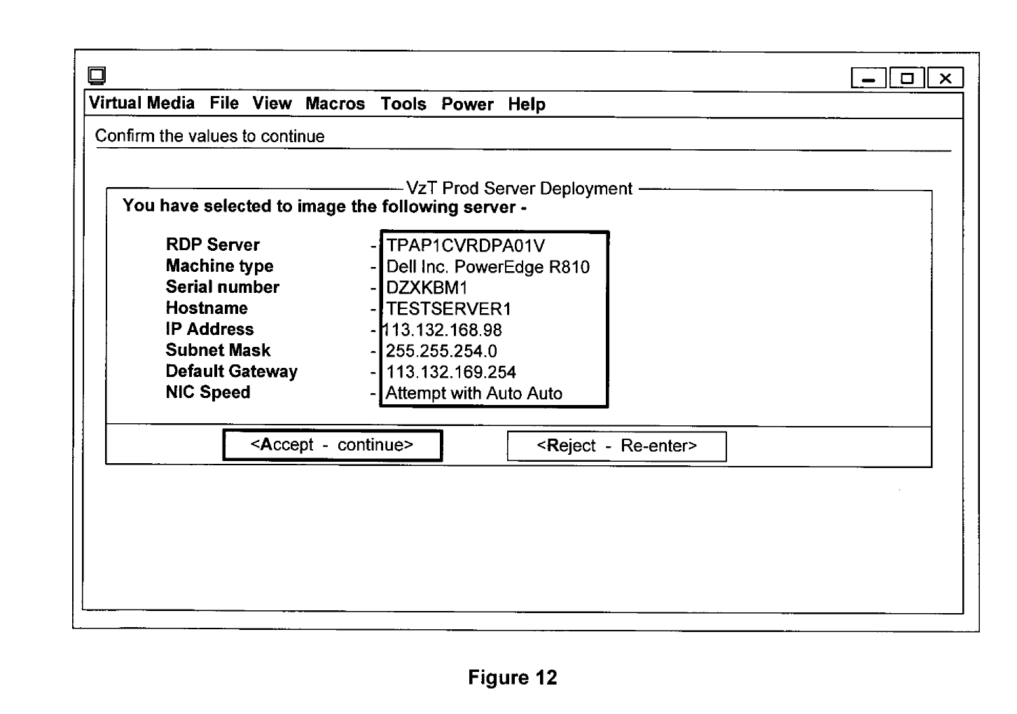

The presentation module 206 may request operating environment information associated with dynamically deployed servers. FIG. 10 shows that the graphical user interface may request the administrator to select an operating system associated with the dynamically deployed servers. The operating environment information associated with the dynamically deployed servers may include domain information or directory information for the operating environment. FIG. 11, shows that the graphical user interface may request the administrator to select an domain or directory information of the dynamically deployed servers. The graphical user interface may request that the administrator to verify the accuracy of the information provided by the administrator. FIG. 12, shows that the graphical user interface displaying information provided by the administrator and requesting the administrator to verify the accuracy of the information.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A method, comprising:
establishing a communication link with a deployment client workstation;
capturing data associated with the deployment client workstation;
creating a deployment file based at least in part on the data associated with the deployment client workstation; and
providing the deployment file to a deployment server engine via a network.

2. The method according to claim 1, wherein the communication link is a wired link.

3. The method according to claim 1, wherein the communication link is a wireless link.

4. The method according to claim 1, wherein the deployment client workstation is a workstation associated with a client served by dynamically deployed servers.

5. The method according to claim 1, wherein the data associated with the deployment client workstation comprise at least one of hardware information associated with the deployment client workstation and software information associated with the deployment client workstation.

6. The method according to claim 1, further comprising receiving information from an administrator.

7. The method according to claim 6, wherein the information from the administrator comprise at least one of identification information, business unit information, server location, server identification, network information, and operating system.

8. The method according to claim 6, wherein the deployment file is created at least in part on the data provided by the administrator.

9. The method according to claim 1, further comprising providing the deployment file to the deployment client workstation.

10. A non-transitory computer readable medium storing an executable program comprising instructions to perform the method of claim 1.

11. A method, comprising
receiving a first deployment file from a deployment workstation;
receiving a second deployment file from a deployment client workstation;
matching the first deployment file from the deployment workstation with the second deployment file from the deployment client workstation; and
deploying servers based at least in part on a match of the first deployment file from the deployment workstation with the second deployment file from the deployment client workstation.

12. The method according to claim 11, further comprising storing the first deployment file from the deployment workstation in a deployment server database.

13. The method according to claim 11, further comprising capturing deployment and configuration data associated with the deployed servers.

14. The method according to claim 13, further comprising providing the deployment and configuration data to the deployment client workstation.

15. A non-transitory computer readable medium storing an executable program comprising instructions to perform the method of claim 11.

16. A system, comprising:
a client module configured to establish a communication link with a deployment client workstation and capture data associated with the deployment client workstation;
a processing module having one or more processors configured to create a deployment file based at least in part on the data associated with the deployment client workstation; and
an input/output module configured to provide the deployment file to a deployment server engine via a network.

17. The system according to claim 16, wherein the data associated with the deployment client workstation comprise at least one of hardware information associated with the deployment client workstation and software information associated with the deployment client workstation.

18. The system according to claim 16, further comprising a presentation module configured to receive information from an administrator.

19. The system according to claim 20, wherein the information from the administrator comprise at least one of identification information, business unit information, server location, server identification, network information, and operating system.

20. The system according to claim 16, wherein the deployment file is created at least in part on the data provided by the administrator.

21. The system according to claim 16, wherein the input/output module is further configured to provide the deployment file to the deployment client workstation.
